(19) United States
(12) Patent Application Publication
(10) Pub. No.: US 2001/0036165 A1
(43) Pub. Date: Nov. 1, 2001

(54) CDMA wireless base station

(75) Inventor: Takashi Suzuki, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/829,618

(22) Filed: Apr. 10, 2001

(30) Foreign Application Priority Data
Apr. 12, 2000 (JP) 111343/2000

(51) Int. Cl. H04B 7/216

(52) U.S. Cl. 370/335; 370/342

(57) ABSTRACT

An increase in the transmission power level of an upstream signal from a mobile terminal due to a failure of a baseband processing section is inhibited and the interference of the upstream signal with upstream signals sent from other mobile terminals is prevented. If a failure occurs in a user correlation value detector 22-3 provided in a baseband processing section 22a of a transmitter/receiver 20, an abnormal operation signal is sent from a failure detector 22-9 that detects the failure to an alarm signal generator 22-5. When an alarm signal is sent from the alarm signal generator 22-5 which receives the abnormal operation signal to an alarm monitor 23, the alarm monitor 23 sends a decoding discontinuation signal to a decoder 22-4 and a power controller 22-6 generates a TPC bit instructing the mobile terminal to decrease the transmission power level of the upstream signal from the mobile terminal to a lower level. The generated TPC it is added to a downstream signal in a downstream data processing section 22-2 and the downstream signal is sent to the mobile terminal.

### BACKGROUND OF THE INVENTION

The present invention relates to a CDMA wireless base station and, in particular, to a CDMA wireless base station having a plurality of baseband processing sections.

### DESCRIPTION OF THE RELATED ART

In CDMA (Code Division Multiple Access), which is one of access control methods in the mobile communication field, an upstream signal which is code-division-multiplexed and sent from a mobile terminal is reverse-spread and decoded in a base station to obtain communication data contained in the upstream signal.

Because a plurality of upstream signals sent form the mobile terminal in CDMA use the same spectrum, an interference wave is produced due to a difference in the transmission power level.

The interference is also affected by the geography and distance between the mobile terminal and the base station. The higher the transmission power level of the mobile terminal, the larger the interference provided.

To solve the interference problem, a process called the power control is performed in the CDMA wireless base station.

The power control is a process for monitoring and controlling the level of upstream signals sent from a mobile terminal so that level of the transmission power of all the upstream signals become equal.

The flow of the upstream signal in the CDMA wireless base station performing the power control will be described with reference to FIGS. 7 and 8.

FIG. 7 is a block diagram of a CDMA wireless base station according to a prior art. FIG. 8 is a block diagram showing the internal configuration of the transmitter/receiver of the CDMA wireless base station and a baseband processing section provided in the transmitter/receiver.

First, upper signals sent from a plurality of mobile terminals, which are not shown, is received by an antenna section 100 shown in FIG. 7 and sent to a wireless interface (I/F) 210 in the transmitter/receiver 200.

The upstream signals are analog signals having code-division-multiplexed communication data.

The upstream signal received by the wireless I/F 210 is detected in synchronization with a baseband spectrum, analog-to-digital-converted, and sent to a user correlation value detector 221-1 shown in FIG. 8.

A synchronization catching/tracking section 221-1-1 in the user correlation value detection section 221-1 detects the synchronous timing of the received upstream signal, then a reverse-spreading section 221-1-2 reverse-spreads the upstream to calculates the correlation value for a target mobile terminal.

The reverse-spread upstream signal is then decoded by a decoder 221-2, converted into a transmission format specified by the system in a transmission-path I/F 230, and sent to a higher-level station, which is not shown.

In addition, process data obtained by the decoder 221-2 is sent to a power controller 221-3.

In the power controller 221-3, the SIR (Signal to Interference Ratio) of the process data received is measured and a TPC bit is generated based on the upstream transmission power level obtained as the result of the measurement.

The generated TPC bit is sent from the power controller 221-3 to a downstream data processing section 222.

In the downstream data processing section 222, the received TPC bit is added to a downstream signal and sent to the mobile terminal.

In the mobile terminal, the TPC bit added to the downstream signal received is detected and the upstream signal is sent at the transmission power level according to the TCP bit to the CDMA wireless base station.

In the CDMA wireless base station controlling the power of the upstream signal as described above, the transmission power levels of the plurality of upstream signals received by the transmitter/receiver become equal, thus avoiding interference between the signals.

However, if the user correlation value detector 221-1 cannot operate correctly in the prior-art CDMA wireless base station, an abnormal upstream signal is output and therefore the decoder 221-2 decodes the received abnormal upstream signal and the power controller 211-3 generates an incorrect TPC bit.

Furthermore, if a downstream signal to which an incorrect TCP bit is added is sent to the mobile terminal, the mobile terminal sends an upstream signal at an incorrect transmission power level based on the received TPC bit.

If a signal having an abnormally high transmission power level is sent from the mobile terminal, the signal strongly interferes with upstream signals from other mobile terminals.

Thus the receiving level of the other mobile terminals from which the CDMA wireless base station receives signals is decreased.

The present invention has been made to solve the above-mentioned problem and it is an object of the present invention to provides a CDMA wireless base station that discontinues decoding an abnormal upstream signal output due to a failure of a baseband processing section to inhibit a rise in the transmission power level of the subsequent upstream signal and to prevent interference with upstream signals from other mobile terminals.

### SUMMARY OF THE INVENTION

To achieve the above-mentioned object, a CDMA wireless base station according to claim 1 of the present invention is a CDMA wireless base station for sending and receiving a signal to and from a mobile terminal, comprising: a plurality of baseband processing sections having a user correlation value detector, an alarm signal generator, a decoder, a power controller, and a downstream data processing section; and an alarm monitor connected to the alarm signal generator and the decoder provided in each of the plurality of baseband processing sections; wherein the alarm signal generator in the baseband processing section outputs an alarm signal if the alarm signal generator detects an abnormal operation in the user correlation value detector; the alarm monitor receives an alarm signal output from the alarm signal generator and sends a decoding discontinuation signal to the decoder provided in a baseband processing section having the alarm signal generator outputting the alarm signal; the decoder discontinues decoding if the decoder receives the decoding discontinuation signal; the power controller generates a TPC bit instructing the mobile terminal to decrease the transmission power level associated with an upstream signal sent from the mobile terminal if the power controller detects the discontinuation of decoding in the decoder; and the downstream data processing section receives the TPC bit generated by the power controller and adds the TPC bit to a downstream signal to be sent to the mobile terminal.

In the CDMA wireless base station configured in this way, if an abnormal operation occurs in one of the plurality of baseband processing sections due to a failure or the like, the baseband processing section in which the abnormal operation occurs can be identified.

In addition, the decoder provided in the identified baseband processing section is caused to discontinue decoding and a TPC bit is generated by the power controller for instructing the mobile terminal to decrease the transmission power level of an upstream signal, thereby preventing an increase in the transmission power level of the upstream signal from the mobile terminal and inhibiting the signal from interfering with upstream signals from other mobile terminals.

Furthermore, the alarm monitor is provided in the CDMA wireless base station, the operation of a defective baseband processing section and the other baseband processing sections can be controlled properly through the alarm monitor when the transmitter/receiver performs a user assignment process, operation reset process, and other processes on the plurality of baseband processing sections.

A CDMA wireless base station according to claim 2 of the present invention is configured in a manner that the user correlation value detector comprises a synchronization catching/tracking section for performing a synchronization catching process and a synchronization tracking process for the upstream signal, a reverse-spreading section for performing a reverse-spreading process on the upstream signal, and a counter for managing a count value; the counter outputs an abnormal operation signal if resetting of the count value incrementing sequentially and the count value exceeds a predetermined threshold because the counter does not receive an increment value reset signal from the synchronization catching/tracking section and/or the reverse-spreading section, the increment value reset signal being output at predetermined time intervals according to the synchronization catching process and/or the synchronization tracking process in the synchronization catching/tracking section and/or the reverse-spreading process in the reverse spreading section; the alarm signal generator outputs the alarm signal if the alarm signal generator receives the abnormal operation signal output from the counter.

In the CDMA wireless base station configured in this way, an abnormal operation in the user correlation value detector can be detected without fail.

A CDMA wireless base station according to claim 3 comprises a parallel-serial converter connected between the alarm monitor and the plurality of alarm signal generators; and a serial-parallel converter connected between the alarm monitor and the plurality of alarm signal generators; wherein the parallel-serial converter receives an alarm signal output from any of the plurality of alarm signal generators and sends the alarm signal to the alarm monitor; and the serial-parallel converter sends decoding discontinuation signal sent from the alarm monitor to the decoder provided in a baseband processing section having the alarm signal generator outputting the alarm signal.

In the CDMA wireless base station configured in this way, the length of wiring connecting the plurality of baseband processing sections and the alarm monitor can be reduced. Therefore, the installation cost can be reduced.

A CDMA wireless base station according to claims 4 is configured in a manner that the alarm signal generator sends the decoding discontinuation signal to the decoder provided in the baseband processing section having the user correlation value detector if the alarm signal generator detects an abnormal operation in the user correlation value detector.

In the CDMA wireless base station configured in this way, decoding discontinuation for handling a failure of a user correlation value detector can be caused by the alarm signal generator provided in the same baseband processing section in which the user correlation value detector is provided.

Therefore, interference between upstream signal during sending and receiving can be prevented quickly.

In a CDMA wireless base station according to claim 5, the decoding discontinuation signal is implemented by an initialization signal.

By implementing the decoding discontinuation signal in this way, the decoder can discontinue decoding by receiving a reset signal. Thus received data is not processed and interference with data received from other mobile terminal due to an increase in the power level of the received data caused by abnormality in the baseband processing section can be reduced.

In a CDMA wireless base station according to claim 6, the TPC bit is implemented by a control signal indicating that the transmission power level is set to the minimum value.

By implementing the TPC bit in this way, the mobile terminal receiving the downstream signal to which the TCP bit is added adjusts the transmission power level associated with the next upstream signal to be sent so that the level is set to the minimum value indicated by the received TPC bit, thus the interference of that upstream signal with upstream signals sent from other mobile terminals can be prevented.

A CDMA wireless base station according to claim 7 is a CDMA wireless base station for sending and receiving a signal to and from a mobile terminal, comprising: a plurality of baseband processing sections having an upstream data processing digital signal processor, an alarm signal generation ASIC, a power control ASIC, and a downstream data processing digital signal processor; and a central processing unit section connected to the alarm signal generation ASIC and the upstream data processing digital signal processor provided in each of the plurality of baseband processing sections; the alarm signal generation ASIC in the baseband processing section outputs an alarm signal if the alarm signal generation ASIC detects an abnormal operation in the upstream data processing digital signal processor; the central processing unit section receives the alarm signal output from the alarm signal generation ASIC and sends a reset signal to the upstream data processing digital signal processor provided in the baseband processing section having the alarm signal generation ASIC outputting the alarm signal; and the upstream data processing digital signal processor performs a process for restoring the settings of an operation program to their initial state if the upstream data processing section receives the reset signal.

In the CDMA wireless base station configured in this way, the alarm monitor can identify an upstream data processing digital signal processor in which operation program abnormality occurs, and the operation program of the upstream data processing digital signal processor can be restored to its initial state, which is the normal state, by a reset signal output by the identification.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram of an internal configuration a CDMA wireless base station according to a first embodiment of the present invention;

FIG. 2 is a block diagram of an internal configuration of a baseband processing section of a CDMA wireless base station according to the first embodiment of the present invention;

FIG. 3 is a block diagram of another internal configuration of a baseband processing section of a CDMA wireless base station according to the first embodiment of the present invention;

FIG. 4 is a block diagram of an internal configuration a CDMA wireless base station according to a second embodiment of the present invention;

FIG. 5 is a block diagram of an internal configuration a CDMA wireless base station according to a third embodiment of the present invention;

FIG. 6 is a block diagram of an internal configuration of a baseband processing section of a CDMA wireless base station according to the third embodiment of the present invention;

FIG. 7 is a block diagram of an internal configuration of a CDMA wireless base station according to a prior art; and

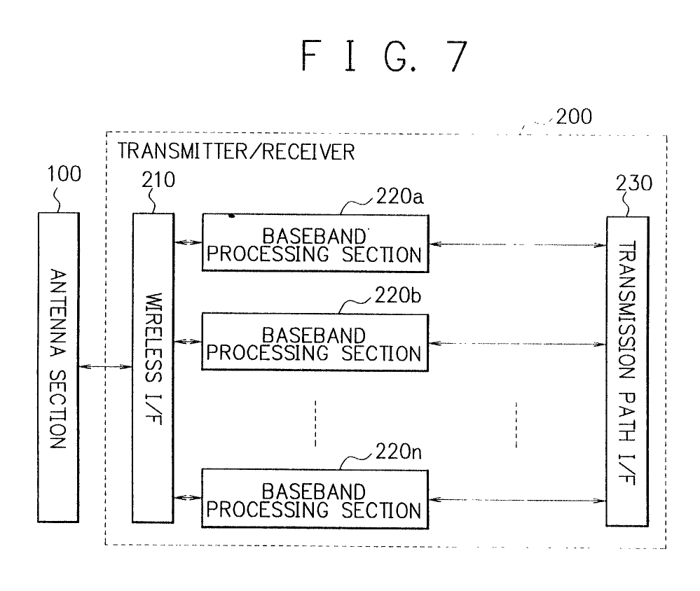

FIG. 8 is a block diagram of an internal configuration of a baseband processing section of a CDMA wireless base station according to the prior art.

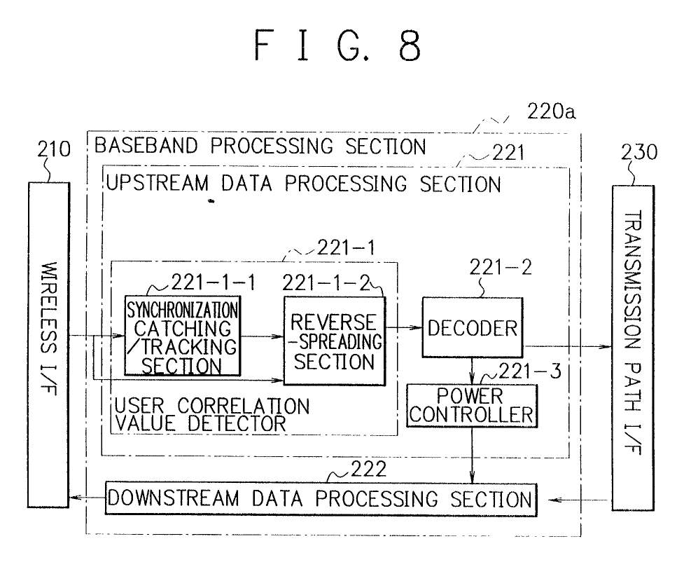

### DESCRIPTION OF THE PREFERRED EMBODIMENTS

Embodiments of the present invention will be described with reference to the accompanying drawings.

### First Embodiment

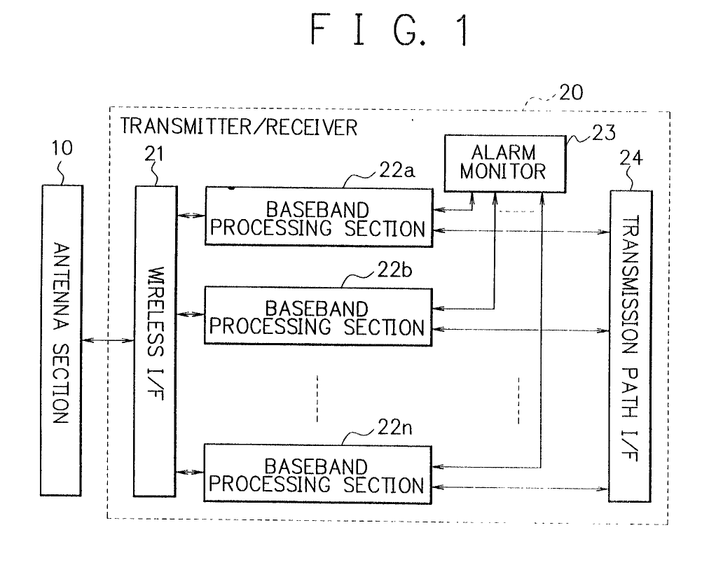

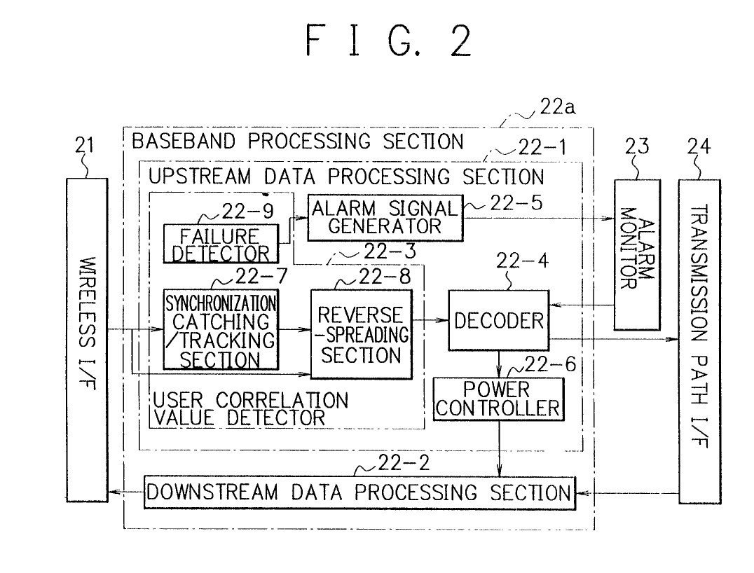

A first embodiment of a CDMA wireless base station according to the present invention will be described with reference to FIGS. 1 and 2.

FIG. 1 is a block diagram of a CDMA wireless base station according to the present embodiment and FIG. 2 is a block diagram showing the internal configuration of a transmitter/receiver and a baseband processing section provided in the transmitter/receiver.

As shown in FIG. 1, the CDMA wireless base station comprises an antenna section 10 and a transmitter/receiver 20.

The antenna section 10 sends and receives signals (upstream signal and down stream signal) communicated between a plurality of mobile terminals and the transmitter/receiver 20.

The transmitter/receiver 20 comprises a wireless interface (I/F) 21, a plurality of baseband processing sections 22a to 22n, an alarm monitor 23, and a transmission pass I/F 24.

The wireless I/F 21 converts the format of the communication signal received or to be sent into a system-specified format.

A plurality (n) of baseband processing sections 22a to 22n is provided for communication with a plurality of mobile terminals.

Each of the baseband processing sections 22a to 22n has an upstream data processing section 22-1 and a downstream data processing section 22-2 as shown in FIG. 2.

While the internal configuration of the baseband processing section 22a is shown in FIG. 2, the other baseband processing section 22b to 22n have the same internal configuration.

The upstream data processing section 22-1 comprises a user correlation value detector 22-3, a decoder 22-4, an alarm signal generator 22-5, and a power controller 22-6.

The user correlation value detector 22-3 comprises a synchronization catching/tracking section 22-7, a reverse-spreading section 22-8, and a failure detector 22-9.

The synchronization catching/tracking section 22-7 performs a synchronization catching process for detecting and outputting the synchronization timing of reverse-spreading in the upstream signal.

The synchronization catching/tracking section 22-7 also performs synchronization tracking for monitoring the synchronization for preventing the synchronization from being lost due to fading or noise caused by the movement of the mobile terminal after synchronization is established by the synchronization catching operation.

The reverse-spreading section 22-8 reverse-spreads a code-division-multiplexed upstream signal by using the same codes as those used by the target mobile terminal for spreading the signal with synchronization timing detected and output by the synchronization catching/tracking section 22-7, and calculates a correlation value for the target mobile terminal from the multiplexed upstream signal.

The calculated correlation value is sent to the decoder 22-4.

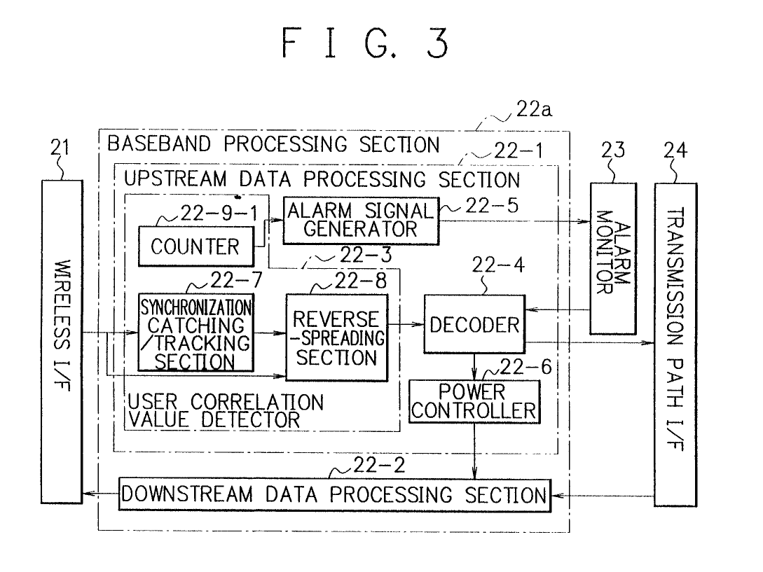

The failure detector 22-9 may be composed of a counter 22-9-1 as shown in FIG. 3.

The counter 22-9-1 has a watchdog alarm (WDALM) function and controls a count value used in synchronization catching and tracking performed by the synchronization catching/tracking section 22-8 and reverse-spreading performed by the reverse-spreading section 22-9.

The WDALM function resets the count value, which otherwise the counter automatically counts up, at predetermined intervals when it receives a counter reset signal, or outputs a watchdog alarm when the counter exceeds a predetermined threshold because it does not receive the reset signal.

The counter 22-9-1 having the WDALM function automatically outputs a normal-state signal while counting the count value, and resets the count value when it receives the reset signal which is output in synchronization catch, synchronization track, and reverse-spread processing.

If it does not receives the reset signal and the count value exceeds the threshold, it outputs an abnormal-state signal (watchdog alarm signal).

The synchronization catching/tracking section 22-8 outputs a reset signal at predetermined time intervals in the synchronization catch processing and synchronization track processing.

The counter 22-9-1 may be provided in the synchronization catching/tacking section 22-7 or the reverse-spreading section 22-8.

The detection of a failure of the user correlation value detector 22-3 performed by the failure detector 22-9 is not limited to the method in which the counter 22-9-1 having the WDALM function is used. For example, the failure may be detected by detecting an error in the synchronization catching/tracking, an abnormal correlation value calculated, or an execution error in an operation program controlling the function of the user correlation value detector.

If these failure detection methods are used, the counter 22-9-1 may be eliminated.

The failure detector 22-9 may output a normal-operation signal constantly, intermittently, or at predetermined time intervals, or may not output it.

The decoder 22-4 decodes an upstream signal coded for the purpose of error control or other purposes.

The alarm signal generator 22-5 determines, based on the normal/abnormal-operation signals sent from the failure detector 22-9, whether the user correlation value detector 22-3 operates properly or not.

If alarm signal generator 22-5 receives the abnormal-operation signal and therefore determines that the user correlation value detector 22-3 operates improperly, it outputs an alarm signal.

By the determination process, the alarm signal generator 22-5 can detect an improper operation of the user correlation value detector 22-3.

The power controller 22-6 performs SIR measurement (receive power level measurement) on process data obtained in the decoder 22-4 and calculates the level of transmission power from a mobile terminal to generate a TPC bit.

The TPC bit may be a signal that prevents the transmission power level of a mobile terminal processed by the user correlation value detector 22-3 from causing a strong interference with other mobile terminals, a control signal for minimizing the transmission power level, for example.

The downstream data processing section 22-2 performs processes such as encoding of a downstream signal to be sent to a mobile terminal and adding an error correction bit to the signal.

The alarm monitor 23 monitors a normal signal and alarm signal and identifies, among the plurality of baseband processing 22a to 22n, a baseband processing section having a defective user correlation value detector 22-3 based on the alarm signal received.

The alarm monitor 23 sends a process discontinuation signal to the decoder 22-4 contained in the identified one of the baseband processing sections 22a to 22n for indicating the discontinuation of decoding.

The process discontinuation signal may be implemented by an initialization signal for causing decoding by the decoder 22-4 to be discontinued.

The alarm monitor 23 may have the capabilities of performing transmission power control, reset control and the allocation, change, and deallocation of users and other processes.

The transmission path I/F 24 performs system-specified data format conversion for sending and receiving a communication signal to and from a higher-level station, which is not shown.

An operation performed by the CDMA wireless base station will be described below with reference to FIGS. 1 and 2.

An upstream signal sent from a mobile terminal is received at the antenna section 10 and sent to the wireless I/F 21.

The upstream signal received by the wireless I/F 21 undergoes a format conversion and is sent to one of the baseband processing section 22a to 22n assigned to the signal.

It is assumed here that the upstream signal is sent from the wireless I/F 21 to the baseband processing section 22a.

The user correlation value detector 22-3 in the baseband processing section 22a receives the upstream signal. Synchronization timing for the upstream signal is detected by the synchronization catching/tracking section 22-7 and reverse-spreading is performed by the reverse spreading section 22-8 to calculate the correlation value for a target mobile terminal.

The failure detector 22-9 of the baseband processing section 22a constantly outputs normal-operation signal and outputs an abnormal-operation signal if a failure of the user correlation value detector 22-3.

The output normal-operation or abnormal-operation signal is received by the alarm signal generator 22-5 and a normal signal for the normal-operation signal or an alarm signal for the abnormal-operation signal is output to the alarm monitor 23.

If the normal-operation signal is received by the alarm monitor 23, communication data obtained through the reverse-spread process by the reverse-spreading section 22-8 is decoded by the decoder 22-4, undergoes transmission format conversion in the transmission path I/F 24, an is sent to a higher-level station.

Process data obtained in the decoder 22-4 is sent from the decoder 22-4 to the power controller 22-6.

In the power controller 22-6, the received process data undergoes SIR processing and a TPC bit which optimizes the transmission power level of the mobile terminal is generated and sent to the downstream data processing section 22-2.

The TPC bit is added to the downstream signal in the downstream data processing section 22-2 and the downstream signal is sent to a mobile terminal.

In the mobile terminal, the TPC bit which is added to the downstream signal received is detected and the upstream signal at a transmission power level controlled by the TPC bit is transmitted.

On the other hand, if the alarm signal is received by the alarm monitor 23, the alarm monitor 23 sends a process discontinuation signal to the decoder 22-4 connected to the user correlation value detector 22-3 in which the failure has occurred.

The decoder 22-4 which received the process discontinuation signal discontinues decoding.

When the decoding in the decoder 22-4 is discontinued, the power controller 22-6 detects the discontinuation of the decoding and generates a TPC bit for instructing the mobile terminal to decrease transmission power level of the upstream signal.

The generated TPC bit is sent from the power controller 22-6 to the data processing section 22-2.

The downstream data processing section 22-2 adds the received TPC bit to a downstream signal and the down stream signal is sent to the mobile terminal.

In the mobile terminal, the transmission power level is controlled according to the TPC bit added to the received downstream signal and the upstream signal is sent to the CDMA wireless base station.

The transmission power level control by the TPC bit can minimize the transmission power level.

N alarm signal generators and the alarm monitor as described above are provided in the CDMA wireless base station and signals from the n alarm signal generators are received and monitored for an alarm, thereby enabling the identification of a defective user correlation value detector.

In addition, by monitoring the user correlation value detectors for an alarm in this way, the control is performed to prevent transmission data from a mobile terminal from interfering with transmission data from other mobile terminals if a failure occurs in any of the user correlation value detectors.

### Second Embodiment

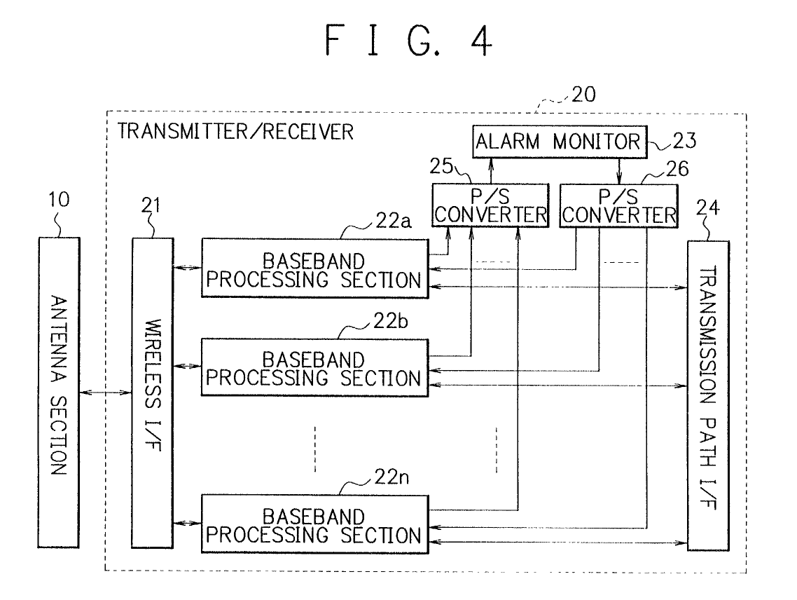

A second embodiment of the CDMA wireless base station of the present invention will be described below with reference to FIG. 4.

FIG. 4 is a block diagram of the internal configuration of the CDMA wireless base station of the present embodiment.

The second embodiment is different from the first embodiment in that a P/S converter and S/P converter are provided between an alarm monitor and baseband processing sections. Other components of the CDMA wireless base station are the same as those in the first embodiment.

Therefore, the same reference numbers are applied to the same components in FIG. 4 as those shown in FIG. 1 and the description thereof will be omitted.

As shown in FIG. 4, the transmitter/receiver 20 of the CDMA wireless base station comprises a wireless I/F 21, baseband processing sections 22a to 22n, an alarm monitor 23, a transmission I/F 24, a P/S converter 25, and S/P converter 26.

The P/S (parallel-serial) converter 25 is connected with the plurality of the baseband processing sections 22a to 22n, receives a normal signal and alarm signal sent form an alarm signal generator 22-5 and sends them to a alarm monitor DSP 23-1.

The S/P converter 26 receives a process discontinuation signal sent form the alarm monitor DSP 23-1 and sent it to a decoder 22-4 of a specified one of the baseband processing sections 22a to 22n.

Configuring the CDMA wireless base station in this way, the wire length between the baseband processing sections 22a to 22n and the alarm monitor DSP 23-1. Therefore, the installation cost can be reduced.

### Third Embodiment

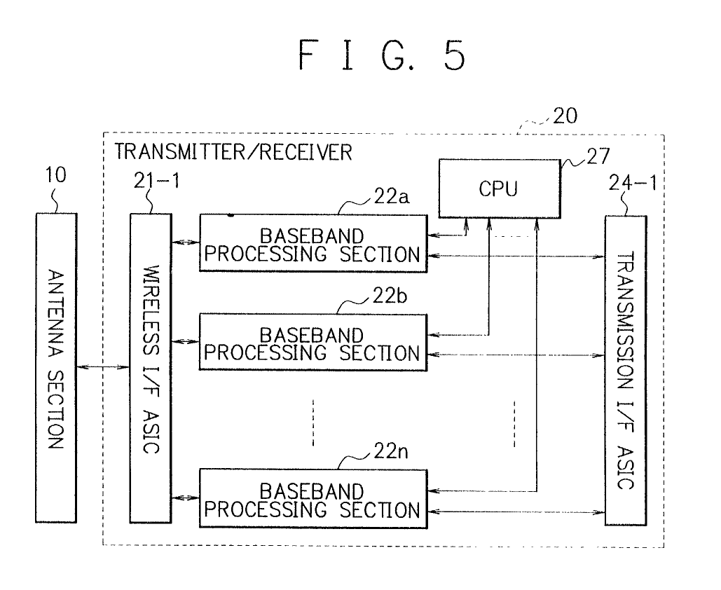

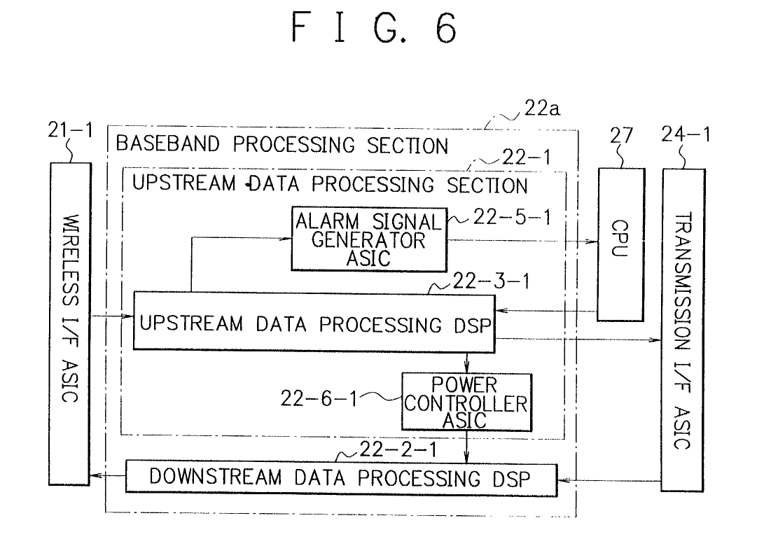

A third embodiment of the CDMA wireless base of the present invention will be described with reference to FIGS. 5 and 6.

FIG. 5 is a block diagram of a CDMA wireless base station according to the present embodiment and FIG. 6 is a block diagram showing the internal configuration of a transmitter/receiver and a baseband processing section provided in the transmitter/receiver.

The third embodiment is different from the first embodiment in that each component comprises an ASIC (Application Specified IC) and a DSP (Digital signal processor) and an alarm monitor is controlled by a CPU. The other components of the CDMA wireless base station is the same as those of the first embodiment.

Therefore, the same reference numbers are applied to the same components in FIGS. 5 and 6 as those shown in FIGS. 1 and 2 and the description thereof will be omitted.

As shown in FIG. 5 a transmitter/receiver 20 in the CDMA wireless base station comprises a wireless I/F ASIC 21-1, a baseband processing sections 22a to 22n, a transmission path I/F ASI 24-1, and a CPU 27 (CPU section).

The wireless I/F ASIC 21-1 is implemented by an ASIC having the capabilities of a wireless I/F 21 and the transmission path I/F ASIC 24-1 is implemented by an ASIC having the capabilities of a transmission path I/F 24.

Each of the baseband processing sections 22a to 22n comprises an upstream processing section 22-1 and a downstream data processing section DSP 22-2-1 as shown in FIG. 6.

The upstream processing section 22-1 has an upstream data DSP 22-3-1, an alarm signal generation ASIC 22-5-1, and a power control ASIC 22-6-1.

The upstream data processing DSP 22-3-1 is implemented by a DSP having the capabilities of a user correlation value detector 22-3 and a decoder 22-4.

The alarm signal generation ASIC 22-5-1 is implemented by an ASIC having the capabilities of an alarm signal generator 22-5 and the power control ASIC 22-6-1 is implemented by an ASIC having the capabilities of a power controller 22-6.

The downstream data processing DSP 22-2-1 is implemented by a DSP having the capabilities of a downstream data processing section 22-2.

The CPU 27 monitors normal alarm signals sent from a plurality of alarm signal generation ASICs 22-5-1 and, if it receives an alarm signal, it sends a reset signal to a defective upstream data processing DSP 22-3-1.

The upstream data processing DSP 22-3-1 performs a reboot process, which is a resetting process of an operation program, when receiving the reset signal.

That is, if the cause of the failure is a software failure in the upstream data processing DSP 22-3-1, settings of the operation program of the upstream data processing DSP 22-3-1 are restored to their initial state.

The resetting to the initial state restores the operation of the upstream data processing DSP 22-3-1 to its normal condition.

If the capability of the defective upstream data processing DSP 22-3-1 is not restored by the rebooting, the power control ASIC 22-6-1 generates a TPC bit that minimizes the transmission power level of a mobile terminal handled by the upstream data processing DSP 22-3-1 and sends it to the downstream data processing DSP 22-2-1.

By configuring the CDMA wireless base station in this way, a defective upstream data processing DSP 22-3-1 can be restored to its normal operation by rebooting it if a logic failure occurs resulting from an incorrect operation of an operation program in the upstream data processing DSP 22-3-1.

As described above, the alarm signal generator and the alarm monitor are provided according to the present invention, thus enabling the detection of a defective baseband processing section among the plurality of baseband processing sections.

Therefore, a restoration process such as rebooting can be performed for the detected baseband processing section.

In addition, the decoder provided in the detected baseband processing section is caused to discontinue decoding, thereby the power controller generates a TPC bit for instructing a mobile terminal to set the transmission power level of an upstream signal to a lower level and the downstream data processing section adds the generated TPC bit to a downstream signal, allowing the transmission power level of the upstream signal from the mobile terminal to be decreased.

Thus, a strong interference of an upstream signal with upstream signals sent from other mobile terminals can be inhibited that has been conventionally caused by the upstream signal having a transmission power level increased by an abnormal power control resulting from a malfunction of a baseband processing section.

The P/S converter and S/P converter is connected between the user correlation value detector and the alarm monitor, thus the wire length can be reduced and the installation cost can be decreased.

In addition, the alarm monitor is provided in the CDMA wireless base station, the operation of a defective baseband processing section and the other baseband processing sections can be controlled properly through the alarm monitor when the transmitter/receiver performs a user assignment process, operation reset process, and other processes on the plurality of baseband processing sections.

What is claimed is:

1. A CDMA wireless base station for sending and receiving a signal to and from a mobile terminal, comprising:
a plurality of baseband processing sections having a user correlation value detector, an alarm signal generator, a decoder, a power controller, and a downstream data processing section; and
an alarm monitor connected to said alarm signal generator and said decoder provided in each of said plurality of baseband processing sections; wherein
said alarm signal generator in said baseband processing section outputs an alarm signal if said alarm signal generator detects an abnormal operation in said user correlation value detector;
said alarm monitor receives an alarm signal output from said alarm signal generator and sends a decoding discontinuation signal to said decoder provided in a baseband processing section having said alarm signal generator outputting said alarm signal;
said decoder discontinues decoding if said decoder receives said decoding discontinuation signal;
said power controller generates a TPC bit instructing said mobile terminal to decrease the transmission power level associated with an upstream signal sent from said mobile terminal if said power controller detects the discontinuation of decoding in said decoder; and
said downstream data processing section receives said TPC bit generated by said power controller and adds said TPC bit to a downstream signal to be sent to said mobile terminal.

2. The CDMA wireless base station according to claim 1, wherein said alarm signal generator sends the decoding discontinuation signal to the decoder provided in the baseband processing section having said user correlation value detector if said alarm signal generator detects an abnormal operation in said user correlation value detector.

3. The CDMA wireless base station according to claim 1, wherein said decoding discontinuation signal comprises a initialization signal.

4. The CDMA wireless base station according to claim 1, wherein said TPC bit comprises a control signal indicating that the transmission power level is set to the minimum value.

5. A CDMA wireless base station for sending and receiving a signal to and from a mobile terminal, comprising:
a plurality of baseband processing sections having a user correlation value detector, an alarm signal generator, a decoder, a power controller, and a downstream data processing section; and
an alarm monitor connected to said alarm signal generator and said decoder provided in each of said plurality of baseband processing sections; wherein
said alarm signal generator in said baseband processing section outputs an alarm signal if said alarm signal generator detects an abnormal operation in said user correlation value detector;
said alarm monitor receives an alarm signal output from said alarm signal generator and sends a decoding discontinuation signal to said decoder provided in a baseband processing section having said alarm signal generator outputting said alarm signal;
said decoder discontinues decoding if said decoder receives said decoding discontinuation signal;
said power controller generates a TPC bit instructing said mobile terminal to decrease the transmission power level associated with an upstream signal sent from said mobile terminal if said power controller detects the discontinuation of decoding in said decoder;
said downstream data processing section receives said TPC bit generated by said power controller and adds said TPC bit to a downstream signal to be sent to said mobile terminal;
said user correlation value detector comprises a synchronization catching/tracking section for performing a synchronization catching process and a synchronization tracking process for the upstream signal, a reverse-spreading section for performing a reverse-spreading process on said upstream signal, and a counter for managing a count value;
said counter outputs an abnormal operation signal if resetting of said count value incrementing sequentially and said count value exceeds a predetermined threshold because said counter does not receive an increment value reset signal from said synchronization catching/tracking section and/or said reverse-spreading section, said increment value reset signal being output at predetermined time intervals according to said synchronization catching process and/or said synchronization tracking process in said synchronization catching/tracking section and/or said reverse-spreading process in said reverse spreading section;
said alarm signal generator outputs the alarm signal if said alarm signal generator receives the abnormal operation signal output from said counter.

6. The CDMA wireless base station according to claim 5, wherein said alarm signal generator sends the decoding discontinuation signal to the decoder provided in the baseband processing section having said user correlation value detector if said alarm signal generator detects an abnormal operation in said user correlation value detector.

7. The CDMA wireless base station according to claim 5, wherein said decoding discontinuation signal comprises a initialization signal.

8. The CDMA wireless base station according to claim 5, wherein said TPC bit comprises a control signal indicating that the transmission power level is set to the minimum value.

9. A CDMA wireless base station for sending and receiving a signal to and from a mobile terminal, comprising:
a plurality of baseband processing sections having a user correlation value detector, an alarm signal generator, a decoder, a power controller, and a downstream data processing section;
an alarm monitor connected to said alarm signal generator and said decoder provided in each of said plurality of baseband processing sections; and a parallel-serial converter connected between said alarm monitor and said plurality of alarm signal generators; and
a serial-parallel converter connected between said alarm monitor and said plurality of alarm signal generators; wherein
said alarm signal generator in said baseband processing section outputs an alarm signal if said alarm signal generator detects an abnormal operation in said user correlation value detector;
said alarm monitor receives an alarm signal output from said alarm signal generator and sends a decoding discontinuation signal to said decoder provided in a baseband processing section having said alarm signal generator outputting said alarm signal;
said decoder discontinues decoding if said decoder receives said decoding discontinuation signal;
said power controller generates a TPC bit instructing said mobile terminal to decrease the transmission power level associated with an upstream signal sent from said mobile terminal if said power controller detects the discontinuation of decoding in said decoder;
said downstream data processing section receives said TPC bit generated by said power controller and adds said TPC bit to a downstream signal to be sent to said mobile terminal;
said parallel-serial converter receives an alarm signal output from any of said plurality of alarm signal generators and sends said alarm signal to said alarm monitor; and
said serial-parallel converter sends decoding discontinuation signal sent from said alarm monitor to said decoder provided in a baseband processing section having the alarm signal generator outputting the alarm signal.

10. The CDMA wireless base station according to claim 9, wherein said alarm signal generator sends the decoding discontinuation signal to the decoder provided in the baseband processing section having said user correlation value detector if said alarm signal generator detects an abnormal operation in said user correlation value detector.

11. The CDMA wireless base station according to claim 9, wherein said decoding discontinuation signal comprises a initialization signal.

12. The CDMA wireless base station according to claim 9, wherein said TPC bit comprises a control signal indicating that the transmission power level is set to the minimum value.

13. A CDMA wireless base station for sending and receiving a signal to and from a mobile terminal, comprising:
a plurality of baseband processing sections having a user correlation value detector, an alarm signal generator, a decoder, a power controller, and a downstream data processing section;
an alarm monitor connected to said alarm signal generator and said decoder provided in each of said plurality of baseband processing sections; and a parallel-serial converter connected between said alarm monitor and said plurality of alarm signal generators; and
a serial-parallel converter connected between said alarm monitor and said plurality of alarm signal generators; wherein
said alarm signal generator in said baseband processing section outputs an alarm signal if said alarm signal generator detects an abnormal operation in said user correlation value detector;
said alarm monitor receives an alarm signal output from said alarm signal generator and sends a decoding discontinuation signal to said decoder provided in a baseband processing section having said alarm signal generator outputting said alarm signal;
said decoder discontinues decoding if said decoder receives said decoding discontinuation signal;
said power controller generates a TPC bit instructing said mobile terminal to decrease the transmission power level associated with an upstream signal sent from said mobile terminal if said power controller detects the discontinuation of decoding in said decoder;
said downstream data processing section receives said TPC bit generated by said power controller and adds said TPC bit to a downstream signal to be sent to said mobile terminal;
said user correlation value detector comprises a synchronization catching/tracking section for performing a synchronization catching process and a synchronization tracking process for the upstream signal, a reverse-spreading section for performing a reverse-spreading process on said upstream signal, and a counter for managing a count value;
said counter outputs an abnormal operation signal if resetting of said count value incrementing sequentially and said count value exceeds a predetermined threshold because said counter does not receive an increment value reset signal from said synchronization catching/tracking section and/or said reverse-spreading section, said increment value reset signal being output at predetermined time intervals according to said synchronization catching process and/or said synchronization tracking process in said synchronization catching/tracking section and/or said reverse-spreading process in said reverse spreading section;
said alarm signal generator outputs the alarm signal if said alarm signal generator receives the abnormal operation signal output from said counter;
a parallel-serial converter connected between said alarm monitor and said plurality of alarm signal generators;
said parallel-serial converter receives an alarm signal output from any of said plurality of alarm signal generators and sends said alarm signal to said alarm monitor; and
said serial-parallel converter sends decoding discontinuation signal sent from said alarm monitor to said decoder provided in a baseband processing section having the alarm signal generator outputting the alarm signal.

14. The CDMA wireless base station according to claim 13, wherein said alarm signal generator sends the decoding discontinuation signal to the decoder provided in the baseband processing section having said user correlation value detector if said alarm signal generator detects an abnormal operation in said user correlation value detector.

15. The CDMA wireless base station according to claim 13, wherein said decoding discontinuation signal comprises a initialization signal.

16. The CDMA wireless base station according to claim 13, wherein said TPC bit comprises a control signal indicating that the transmission power level is set to the minimum value.

17. A CDMA wireless base station for sending and receiving a signal to and from a mobile terminal, comprising:
a plurality of baseband processing sections having an upstream data processing digital signal processor, an alarm signal generation ASIC, a power control ASIC, and a downstream data processing digital signal processor; and
a central processing unit section connected to said alarm signal generation ASIC and said upstream data processing digital signal processor provided in each of said plurality of baseband processing sections;
said alarm signal generation ASIC in said baseband processing section outputs an alarm signal if said alarm signal generation ASIC detects an abnormal operation in said upstream data processing digital signal processor;
said central processing unit section receives the alarm signal output from said alarm signal generation ASIC and sends a reset signal to said upstream data processing digital signal processor provided in the baseband processing section having said alarm signal generation ASIC outputting said alarm signal; and
said upstream data processing digital signal processor performs a process for restoring the settings of an operation program to their initial state if said upstream data processing section receives said reset signal.
